(19) United States
(12) Patent Application Publication
(10) Pub. No.: US 2020/0120970 A1
(43) Pub. Date: Apr. 23, 2020

(54) EXTRUDED, RETORT-STABLE PET FEEDS

(71) Applicant: Wenger Manufacturing Inc., Sabetha, KS (US)

(72) Inventors: Galen J. Rokey, Sabetha, KS (US); LaVon Wenger, Sabetha, KS (US); Lafe Bailey, Morrill, KS (US)

(73) Assignee: Wenger Manufacturing Inc., Sabetha, KS (US)

(21) Appl. No.: 16/406,151

(22) Filed: May 8, 2019

Related U.S. Application Data
(60) Provisional application No. 62/746,635, filed on Oct. 17, 2018.

(51) Int. Cl. A23P 30/20; A22C 7/00; A47J 27/04; A22C 17/00; A23K 10/20; A23K 40/25; A23K 50/42; A23K 50/48; A23L 13/60

(52) U.S. Cl. CPC A23P 30/20; A22C 7/00; A47J 27/04; A22C 17/0026; A23V 2002/00; A23K 40/25; A23K 50/42; A23K 50/48; A23L 13/60; A23K 10/20

(57) ABSTRACT

Extrusion processes for the production of retort-stable feed products comprise forming a mixture of feed ingredients and subjecting the mixture to specific mechanical energy (SME) and specific thermal energy (STE) inputs to achieve low SME/STE ratios, followed by retorting of the extruded products. The extrusion system (20) includes a preconditioner (22), extruder (24), and a two-stage drying assembly (26/28). The extruded products may be retorted directly from the extruder or after partial or complete drying thereof.

### CROSS-REFERENCE TO RELATED APPLICATION

This application claims the benefit of US Provisional Application SN 62/746,635 filed Oct. 17, 2018, which is incorporated by reference herein in its entirety.

### BACKGROUND OF THE INVENTION

### Field of the Invention

The present invention is broadly concerned with extrusion processes yielding feed products having excellent retort stability, allowing the products to be successfully retorted immediately after extrusion or after partial or complete drying thereof. More particularly, the invention is concerned with such processes, and the resultant feeds, characterized by very low ratios of specific mechanical energy (SME) inputs to specific thermal energy (STE) inputs, as well as corresponding preconditioning and extrusion parameters. The invention may be used to economically produce high meat content feeds particularly desired by pet owners.

### Description of the Prior Art

Many animal feed products are produced using extrusion equipment. For example, the majority of dog and cat feeds are extrusion products. In general, extrusion equipment and processing conditions are well known in the art for conventional products, such as standard pet feeds containing quantities of proteins, fats, and starch. Such extruded feeds can be supplemented with relatively small amounts of meats using conventional equipment and processing techniques. The prior art extrusion processes typically make use of SME and STE inputs, which result in SME/STE ratios on the order of 1.6:1 and above, with an average of perhaps 2.5:1.

U.S. Pat. No. 10,028,516 describes improved processes and equipment for the production of high meat quantity feeds, up to and even in excess of 80% by weight meat.

Many canned or pouched pet feed products are retorted in order to improve the shelf life thereof. This is particularly the case with, for example, high meat content canned dog feeds not produced by extrusion. However, it has been found very difficult to successfully retort conventional extruded kibble or other types of animal feeds, because such products do not have sufficient integrity to withstand retorting conditions. When these feeds are retorted, they exhibit high degrees of mushiness and lack recognizable structure or shape making them unsuitable for sale.

U.S. Pat. No. 5,456,934 describes a process for producing retort-stable extruded food pieces. This patent teaches that the feed ingredients must contain at least about 20% by weight of both wheat gluten and wheat flour, together with other preferred ingredients. This limits the utility of the processes, particularly where high meat content feeds are desired. Furthermore, the processes of the '934 patent involve first moisturizing the dry feed ingredients and mixing them under conditions to achieve a temperature of from about 15-45° C. Thereafter, the mixture is formed using a single screw extruder imparting SME levels of from about 6-70 watt.hr/kg (or its equivalent kWhr/T). However, the process does not involve any significant STE inputs during extrusion, and only moderate STE inputs during preliminary mixing. As such, it is believed that the SME/STE ratios attendant to the process of the '934 patent are relatively high.

### SUMMARY OF THE INVENTION

The problems outlined above are beneficially addressed by the processes of the present invention, and such processes provide retort-stable pet feeds using virtually any pet feed recipe including ultra-high meat recipes containing 80% by weight meat or greater. Generally speaking, in one aspect of the invention, a process is provided for preparing feed products comprising the steps of forming a mixture of feed ingredients, subjecting the mixture to specific mechanical energy and specific thermal energy inputs, including the step of extruding the mixture to produce an extrudate, and retorting the extrudate. The ratio of the total specific mechanical energy input to the total specific thermal energy input in the process prior to retorting ranges from about 0.1:1-0.95:1, and more preferably from about 0.15:1-0.85:1. The processes may be carried out using known extrusion equipment, by first preconditioning the mixture of feed ingredients in order to moisturize and partially pre-cook the mixture, and thereafter extruding the mixture, taking care that the SME/STE ratios are kept low. The extruder may be of single screw design, but more advantageously twin-screw extruders are employed.

The preconditioning step comprises injecting steam and/or water into the feed mixture while agitating the mixture for a period of from about 0.5-2.5 minutes so that the preconditioned mixture has an exit temperature of from about 55-95° C. In this fashion, the mixture is pre-cooked to a cook value of from about 15-60%, more preferably from about 25-50%. An HIP preconditioner commercialized by Wenger Manufacturing Inc. of Sabetha, Kans., may be used in this context, and such equipment is described in U.S. Pat. No. 7,906,166.

The extruder includes an elongated barrel with an endmost restricted orifice die, and at least one elongated, axially rotatable, helically flighted screw within the barrel. In certain embodiments, steam is injected directly into the extruder barrel during processing, although this is not essential. Additionally, in other embodiments, use may be made of hollow-core extrusion screw(s), which permits injection of heat exchange media into the body of the screw(s), providing a further measure of heat input to the process. During extrusion, the screw(s) are typically rotated at a rate of from about 200-700 rpm; a maximum pressure of from about 3200-8500 kpa is established within the barrel; and the mixture is retained within the barrel for a retention time of from about 12-40 seconds. Normally, the extrudate is cut as it emerges from the die to provide convenient pellet or kibble products. The extrudates of the invention typically have a retort integrity index of up to about 1.25, as herein defined.

The extrudate may be immediately retorted, partially dried before retorting, or even fully dried before retorting. Drying of the extrudate is preferably carried out using an initial predryer followed by final drying in a primary dryer to achieve an extrudate moisture level of from about 7-16% by weight. In any case, the retorting step is essentially conventional, and may be carried out in a steam-fed pressure vessel where the extrudate is placed in a sealed container, such as a pouch or can, and the sealed container is subjected to elevated temperatures and pressures over a period of time in order to sterilize the extrudate therein. The extrudate may be retorted alone, or in combination with other feed ingredients.

In another aspect of the invention, processes for preparing feed products comprise the steps of forming a mixture of feed ingredients, preconditioning the mixture by agitating the mixture and adding steam thereto for a period of from about 0.5-2.5 minutes so that the preconditioned mixture has a temperature of from about 55-95° C., extruding the preconditioned mixture in an extruder having an elongated barrel and at least one elongated, axially rotatable, helically flighted screw within the barrel, the extruding step comprising the step of rotating the at least one screw at a rate of from about 200-700 rpm, with the residence time of the preconditioned mixture within the barrel being from about 12-40 seconds, and then retorting the extruded mixture. The above-described features of the invention, such as the SME/STE ratio, preconditioning, extrusion, drying and retorting conditions, may likewise be applicable to this aspect of the invention.

The invention provides a number of important advantages. First and foremost, shaped extrudate pieces are produced which do not substantially dissolve or disintegrate when retorted. This feature is found in both expanded or unexpanded extrudates using virtually any pet feed recipe, and without the need for special binders, such as sulfur or wheat gluten. The processes do not require drying, coating, or cooling after extrusion, and can be directly retorted without any intermediate steps. Preservatives commonly required in pet feeds are not required using the present invention, because the shelf life of the products is extended via retorting in an anaerobic environment which reduces or eliminates the presence of oxygen.

### BRIEF DESCRIPTION OF THE DRAWINGS

FIG. 1 is a schematic representation of the preferred apparatus for producing the products of the present invention;

FIG. 2 is a plan view of the preferred preconditioner used in the preparation of the products of the invention, with the control apparatus for the preconditioner being schematically depicted;

FIG. 3 is a side elevational view of a preferred twin-screw extruder used in the preparation of the products of the invention, in combination with a dispersal hood assembly;

FIG. 4 is a vertical sectional view illustrating the internal construction of the preferred extruder;

FIG. 5 is a vertical sectional view taken along the line 5-5 of FIG. 4 and further depicting the construction of the preferred extruder;

FIG. 6 is a front perspective view of a preferred product delivery hood assembly used in the invention;

FIG. 7 is a side elevational view of the hood assembly;

FIG. 8 is a perspective view of a hollow core extruder screw which may be used in carrying out the invention;

FIG. 9 is a fragmentary elevational view of the screw of FIG. 8;

FIG. 10 is a fragmentary, vertical sectional view of the screw of FIG. 8 illustrating the internal construction thereof;

FIG. 11 is a fragmentary, enlarged cross-sectional view of the screw of FIG. 8;

FIG. 12 is another fragmentary, enlarged cross-sectional view of the screw of FIG. 8;

FIG. 13 is a vertical sectional view along line 13-13 of FIG. 10;

FIG. 14 is a vertical sectional view along line 14-14 of FIG. 10;

FIG. 15 is a schematic side view of a complete apparatus in accordance with the invention, used to make the products thereof; and

FIG. 16 is a schematic side view of another complete apparatus in accordance with the invention, wherein the extruder is equipped with hollow core extruder screws.

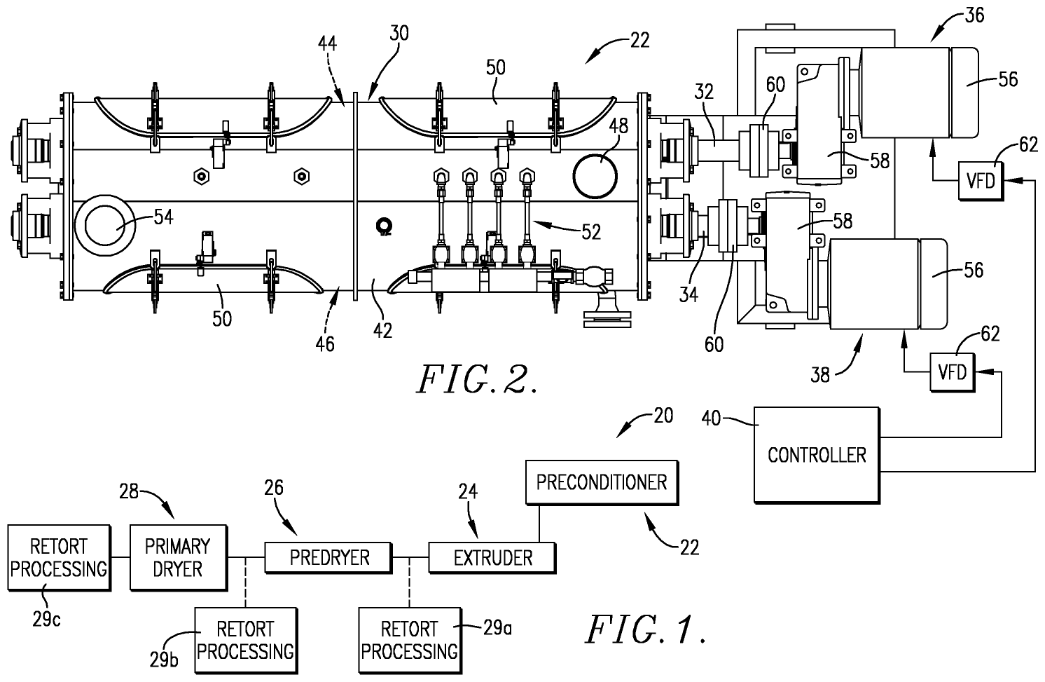

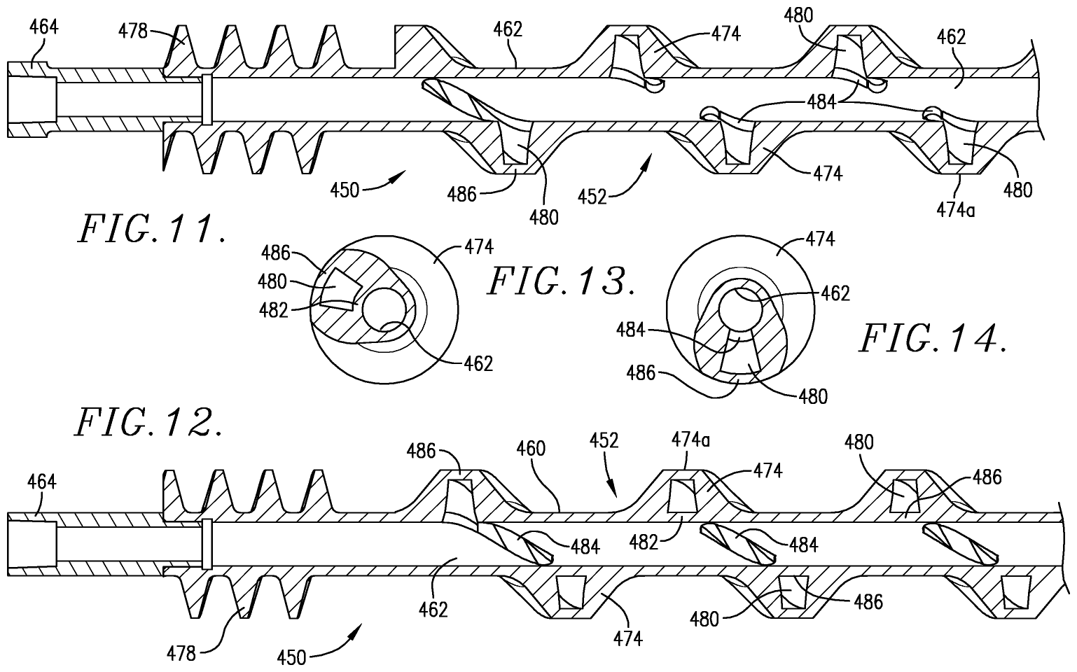

While the drawings do not necessarily provide exact dimensions or tolerances for the illustrated components or structures, FIGS. 1-14 are to scale with respect to the relationships between the components of the structures illustrated therein.

### DETAILED DESCRIPTION OF THE PREFERRED EMBODIMENT

Turning now to the drawings, and particularly FIGS. 1-2 and 4-5, the overall extrusion system 20 broadly includes a preconditioner 22, an extruder 24, a predryer 26, and a primary dryer 28. Alternative retort processing apparatus 29a, 29b, and 29c also form a part of the system 20, as illustrated in FIG. 1.

### The Preconditioner

The preconditioner 22 is of the type illustrated and described in U.S. Pat. No. 7,906,166, incorporated by reference herein in its entirety. Specifically, the preconditioner 22 includes an elongated mixing vessel 30 with a pair of parallel, elongated, axially extending shafts 32 and 34 within and extending along the length of the vessel 30. The shafts 32, 34 are operably coupled with individual variable drive devices 36 and 38, the latter in turn connected with a digital control device 40.

The vessel 30 has an elongated, transversely arcuate sidewall 42 presenting a pair of elongated, juxtaposed, interconnected internal chambers 44, 46, as well as a material inlet 48, and a preconditioned material outlet (not shown) at the end thereof remote from inlet 48. The chamber 46 has a larger cross-sectional area than the adjacent chamber 44. The sidewall 42 has access doors 50 and is also equipped with steam injection apparatus 52 for injection of water and/or steam into the confines of vessel 30 during use of the preconditioner, and a vapor outlet 54.

Each of the shafts 32, 34 has a plurality of radially outwardly extending mixing elements (not shown) which are designed to agitate and mix material fed to the preconditioner, and to convey the material from inlet 48 toward and out the vessel outlet. The mixing elements secured to the shafts are relatively axially offset and are intercalated (i.e., the elements of each shaft extend into the cylindrical operational envelope presented by the other shaft and mixing elements). The mixing elements may be mounted in a substantially perpendicular relationship to the associated shafts, but are preferably adjustable both in length and pitch. The preferred mixing elements are of paddle-like construction, having a shank secured to the associated shaft, with a generally flat, outboard portion of increased width.

The drives 36 and 38 are identical in terms of hardware, and each includes a drive motor 56, a gear reducer 58, and a coupler 60 serving to interconnect the corresponding gear reducer 58 and motor 56 with a shaft 32 or 34. The drives 36 and 038 also preferably have a variable frequency drive 62, which is designed to permit selective, individual rotation of the shafts 32, 34, in terms of speed and/or rotational direction independently of each other. In order to provide appropriate control for the drives 36 and 38, the variable frequency drives 62 are each coupled with a corresponding motor 56 and the control device 40. The latter may be a controller, processor, application-specific integrated circuit (ASIC), or any other type of digital or analog device capable of executing logical instructions. The device may even be a personal or server computer, such as those manufactured and sold by Dell, Hewlett-Packard, Gateway, or any other computer manufacturer, network computers running Windows NT, Novell Netware, Unix, or any other network operating system. The drives 56 may be programmed as desired to achieve the ends of the invention, e.g., they may be configured for different rotational speed ranges, rotational directions, and power ratings.

In preferred forms, the preconditioner 22 is supported on a weighing device such as load cells (not shown), which are also operatively coupled with controller 40. The use of such load cells permits rapid, on-the-go variation in the retention time of material passing through vessel 30, as described in detail in U.S. Pat. No. 6,465,029, incorporated by reference herein.

The use of the preferred variable frequency drive mechanisms 36, 38 and control device 40 allow high-speed adjustments of the rotational speeds of the shafts 32, 34 to achieve desired preconditioning while avoiding any collision between intermeshing mixing elements. In general, the control device 40 and the coupled drives 62 communicate with each drive motor 56 to control the shaft speeds. Additionally, the shafts 32, 34 can be rotated in different or the same rotational directions at the discretion of the operator.

Retention times for material passing through preconditioner 22 can be controlled manually be adjusting shaft speed and/or direction, or, more preferably, automatically through control device 40. Weight information from the load cells is directed to control device 40, which in turn makes shaft speed and/or directional changes based upon a desired retention time.

Preconditioners of the type described are presently being commercialized by Wenger Manufacturing, Inc. of Sabetha, Kans., as HIP (high intensity preconditioner) devices.

### The Extruder

The extruder 24 includes an elongated, tubular, multiple-section barrel 64 presenting juxtaposed, intercommunicated chambers or bores 66, 68, and a pair of elongated, helically flighted, axially rotatable, juxtaposed, intercalated screws 70, 72 within the bores 66, 68. The barrel 64 includes an inlet 74 which communicates with the bores 66, 68. Although not shown, the screws 70, 72 are operably coupled with a drive assembly for axial, co-rotation (i.e., in the same rotational direction) of the screws, which typically includes a drive motor and a gear reduction assembly.

In more detail, the barrel 64 includes, from right to left in FIG. 4, a series of tubular sections connected end-to-end by conventional bolts or other fasteners. Specifically, the barrel 64 has inlet and initial conveying heads 76 and 78, a first steam restriction head 80, a first steam injection head 82, a second steam restriction head 84, an optional, adjustable mid-barrel valve assembly head 86, a second steam injection head 88, and a third steam restriction head 90. As illustrated, each of the heads 76-84 and 88-90 is equipped with conventional endmost, radially enlarged connection flanges, and all of the heads have aligned through bores which cooperatively form the overall barrel bores 66 and 68.

The heads 82 and 88 are equipped with two series of steam injection ports 92, 94, wherein each of the ports houses an elongated steam injector 96, 98. The two series of ports 92, 94 are located so as to respectively communicate with the bores 66, 68 through the heads 82, 88. The ports 92, 94 are oriented at oblique angles relative to the longitudinal axes of the corresponding bores 66, 68; although these ports need not be obliquely oriented, but can be located at a 90° angle relative to the longitudinal axis of the extruder barrel.

The head 86 supports an optional adjustable valve assembly 86a of the type described in U.S. Patent Publication No. US 2007/0237022, incorporated by reference herein in its entirety. Briefly, the assembly 86a includes opposed, slidable, flow restriction components 100, 102, which can be selectively shifted toward and away from the central shafts of the screws 70, 72 so as to vary the restriction upon material flow and thus increase or decrease pressure and shear within the extruder 24.

The screws 70, 72 are identical to each other and thus only one of the screws needs be described in detail. The overall screw 70 broadly includes a central shaft 104 with helical flighting 106 projecting outwardly from the shaft 104. However, the screw 70 is specially designed and has a number of novel features. These features are best described by a consideration of certain geometrical features of the screw 70 and its relationship to the associated bores 66, 68. In particular, the shaft 104 has a root diameter RD indicated by the arrow 108 of FIG. 4, as well as an outermost screw diameter SD defined by the screw flighting 106 and illustrated by the arrow 110. In preferred practice, the ratio SD/RD of the outermost screw diameter to the root diameter is from about 1.9-2.5, and most preferably about 2.35.

The individual sections of screw fighting 106 also have different pitch lengths along the length of screw 70. Additionally, along certain sections of screw 70, there are different free volumes within the bore 68, i.e., the total bore volume in a section less the volume occupied by the screw within that section differs along the length of screw 70.

In greater detail, the screw 70 includes an inlet and initial feed section 112 within heads 76 and 78, a first shorter pitch length section 114 within head 80, a first longer pitch length section 116 within head 82, a second short pitch length section 118 within head 84, a second longer pitch length section 120 within head 88, and a third short pitch length section 122 within head 90. In preferred practice, the pitch lengths of screw sections 114, 118, and 122 range from about 0.25-1.0 screw diameters, and are most preferably about 0.33 screw diameters. The pitch lengths of screw sections 112, 116, and 120 range from about 1-2 screw diameters, more preferably about 1.5 screw diameters.

These geometrical features permit incorporation of greater quantities of steam into the material passing through the extruder 24. In essence, the restriction heads, 80, 84, and 90, together with the short pitch length screw sections 114, 118, and 122, cooperatively create steam restriction zones which inhibit the passage of injected steam past these zones. As such, the zones are a form of steam locks. Additionally, provision of the heads 82 and 88 with the longer pitch length screw sections 116 and 120 therein create steam injection zones allowing injection of greater quantities of steam than heretofore conventional. The longer pitch length screw sections also result in decreased barrel fill and thus create steam injection zones. Finally, the preferred oblique orientation of the injection ports 92 and 94, and the corresponding injectors 96, 98, further enhances the incorporation of steam into the material passing through extruder 10.

The outlet end of extruder barrel 64 is equipped with a transition 124, which is secured to the end of head 90 and to the inlet 126 of a back pressure valve assembly 128. The assembly 128 is essentially conventional, and is designed to provide a selective degree of restriction to flow of material from extruder barrel 64. The valve assembly 128 is illustrated and described in U.S. Pat. No. 6,773,739, wherein the portions thereof directed to the back pressure valve assembly 114 are incorporated by reference herein in their entireties. The outlet 130 of the assembly 128 is operably coupled with a transition 132.

### The Drying Assembly (Predryer 26 and Primary Dryer 28)

The products of the invention are normally in a very wet condition as extruded. Accordingly, it has been found that the as-extruded product is preferably subjected to pre-drying in a relatively small three-pass dryer in order to reduce the moisture content of the extrudate to a level more suitable for a large, more primary dryer. For example, the wet extrudate may have a moisture content of from about 32-50% by weight, based upon the total weight of the extrudate taken as 100% by weight, and a density of from about 500-700 kg/m³, and pre-drying will reduce the moisture content by from about 12-30% by weight. Pre-drying is preferably carried out at a temperature of from about 10-180° C. for a period of from about 1-6 minutes.

After pre-drying, the product is directly fed into a primary dryer 28 where the product is finally dried to a moisture level of from about 7-16% by weight, based upon the total weight of the dried extrudate taken as 100% by weight. The conditions within the primary dryer are a temperature of from about 80-160° C., and a residence time period of from about 12-40 minutes.

### The Dispersal Hood Assembly

In some cases, the wet as-extruded products have a significant tendency toward agglomeration as they emerge from the extruder and/or on conveyor belts typically used as take-away devices. Accordingly, it was found advantageous to employ a dispersal hood mounted adjacent the outlet or die end of extruder 24 in order to overcome the agglomeration problem. Such a dispersal hood assembly is described in U.S. Pat. No. 9,221,627, incorporated by reference herein in its entirety.

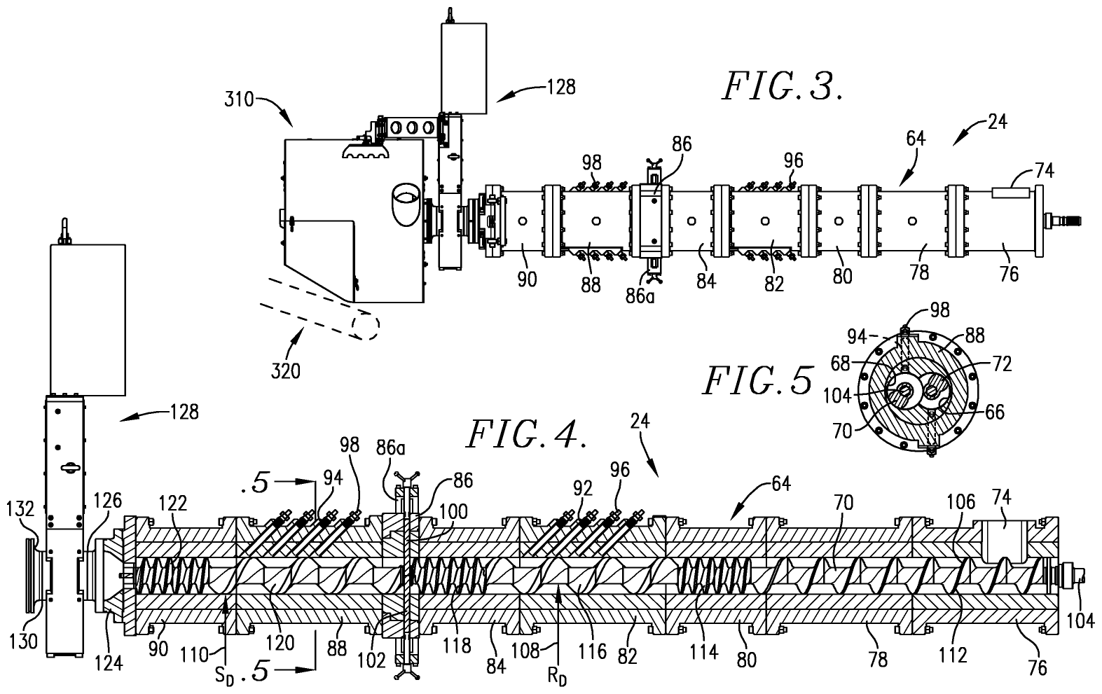

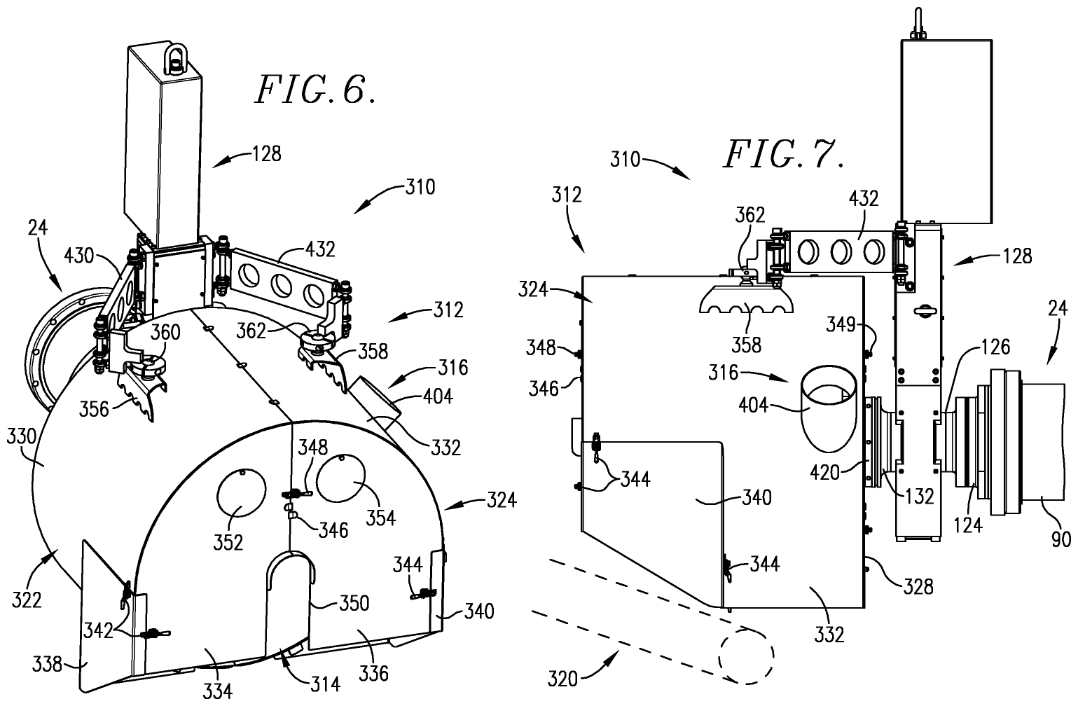

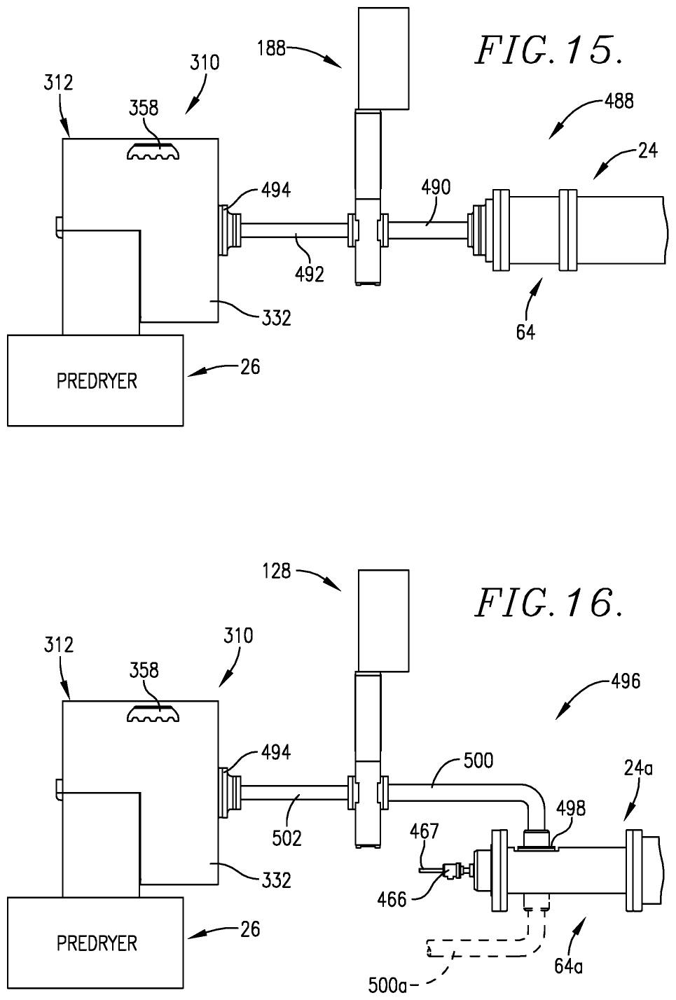

Turning to the drawings, a product-spreading dispersal hood assembly 310 is illustrated in FIGS. 6-7, and broadly includes an outer housing 312 supporting an inner, generally frustoconical deflector 314, made up of mirror-image half-parts, and an air delivery assembly 316. The purpose of hood assembly 310 is to maintain the discrete products issuing from the extruder 24 in a separated condition for delivery onto a take-away device, such as an inlet belt 320 (see FIGS. 3, 7, and 16) or a product predryer 26 (see FIGS. 15-16). In this way, the discrete products are substantially prevented from agglomerating after extrusion and during downstream cooling, drying and/or other processing.

The housing 312 is generally semicircular in overall configuration and includes a pair of shiftable housing halves 322 and 324. The halves 322, 324 are largely mirror images of each other, except for the differences described below. Thus, each housing half includes a rear end wall, such as wall 328, an elongated arcuate sidewall 330, 332, and a forward end wall 334, 336. The sidewalls 330, 332 have detachable, somewhat U-shaped forward panels 338, 340 secured to the sidewalls 330 and 332 by latches 302, 344. The halves 322, 324 cooperatively define the complete overall housing 312 when the walls are placed in adjacency, as illustrated in FIG. 6. In order to ensure proper attachment between the halves 322, 324, the pair of alignment tabs 346 are provided on the butt edges of the front end walls 334, 336, and a fore and aft latches 348 and 349 are provided to interconnect the halves. As depicted in FIG. 6, the front end walls 334, 336 are cooperatively designed to provide a knife drive opening 350, and are also equipped with observation ports 352, 354. A bracket 356, 358 is secured to the outer surface of each sidewall 330, 332 and supports a spherical mount 360, 362.

It will be appreciated that when the halves 322, 324 are closed against each other and latched together, the deflector parts define the substantially frustoconical deflector 314, the latter having a relatively small product inlet opening through the rear walls thereof, and a relatively large forward product outlet opening adjacent the front walls 334, 336.

The air delivery assembly 316 is designed to supply pressurized air into the interior of the housing 312, and to direct such air through an outlet in a direction towards the large diameter open end of the deflector 314.

The extruder 24 in the illustrated embodiment further includes a spacer 420 with an annular extension which supports the extruder die plate. A multiple-blade rotary cutoff knife (not shown) is positioned against the outer face of the extruder die plate and serves to cut the extrudate emerging from the die plate into discrete pieces.

In the operation of hood assembly 310, the use of air delivery assembly 316 is optional, i.e., with some products, it is unnecessary to provide pressurized air currents within the housing 312.

### Alternate Extruder Design Using Hollow Core Screws

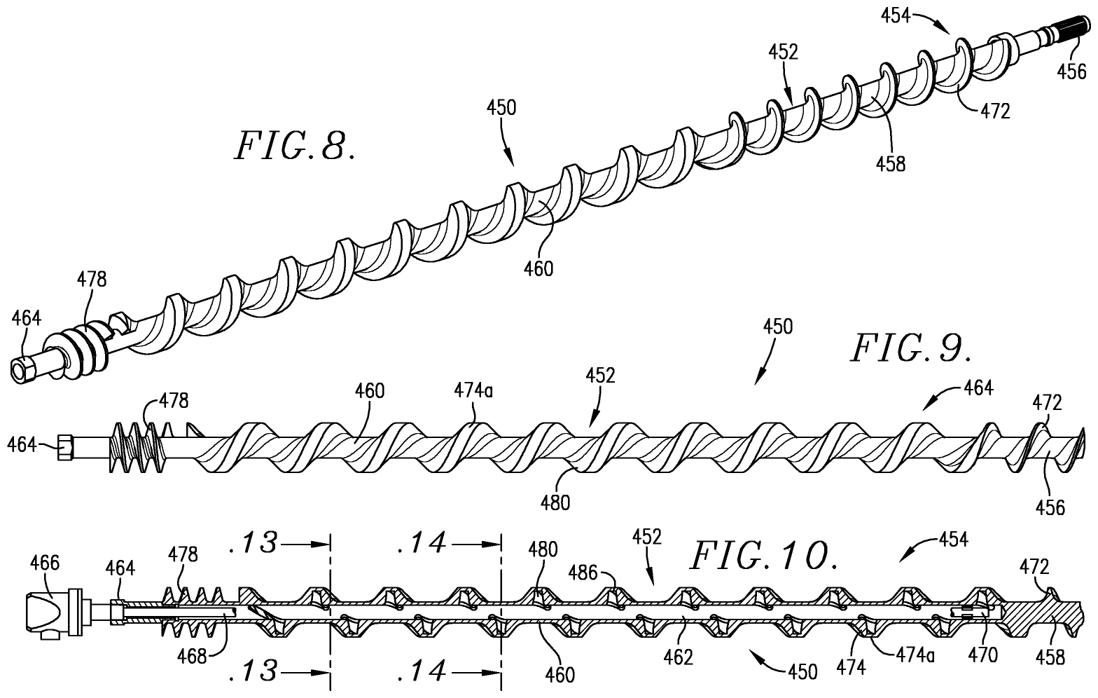

The extruder 22 described above makes use of conventional solid extruder screws. In certain instances, however, better results may be obtained through the use of hollow core screws permitting injection of heat exchange media, such as steam, into and along the length of the screws. Such hollow core screws are described in US Patent Publication No. 2018/0229197, incorporated by reference herein in its entirety. That publication describes a number of different embodiments, but the embodiment of FIGS. 12-18 of the publication is presently most preferred and is described below in conjunction with present FIGS. 8-14.

FIGS. 8-14 illustrate a hollow core screw embodiment of the invention in the form of a helical extrusion screw 450. The screw 450 is designed for use in a twin-screw extruder, so that a mating screw (not shown) will be used in conjunction with the screw 450 to make a screw set.

Generally, the screw 450 includes an elongated central shaft 452 with a continuous helical fighting 454 along the length thereof.

The shaft 452 has a rearmost splined section 456 to afford a driving connection with a motor/gear reducer assembly, and a forward bearing extension. The shaft 452 is a machined, case-hardened part and has a solid rear section 458 and a hollow core forward section 460 presenting an elongated, axially extending, central core 462. The forward end of the core 462 is equipped with a coupler 464 designed to receive a rotary union 466 (FIG. 14). A stationary steam delivery tube 468 (shown fragmentarily in FIG. 14) extends substantially the full length of the core 462 and has an open end 470. The fighting 454 includes a rear section 472 of relatively narrow flight width, which extends the full length of the solid section 458. Additionally, the fighting 454 has a wider flight width forward section 474 presenting an outermost flight surface 474a, which extends from the end of section 472 to a point close to the forward end of the shaft 452. However, as in the case of the earlier embodiments, the screw 450 has a reverse flight section 478 between the end of section 474 and coupler 464.

In the manufacture of the screw 450, the fighting 454 is machined as a solid protrusion from the shaft 452, with a continuous, helical, open-top groove 480 in the wide flight section 474, extending from the outermost flight surface 474a inwardly to an inner wall 482 close to the core 462. Thereafter, a series of spaced apart apertures 484 are formed along the length of the inner wall 482, in order to communicate the core 462 with groove 480. Next, a helical cover piece 486 is positioned over the upper end of the groove 480, and is welded to the fighting section 474. In the final step, the screw 450 is machined to provide the proper outside diameter for the flighting 454. This creates a unitary construction, as illustrated in the drawings.

The operation of the screw 450, with its mating, intermeshed screw within an extruder barrel, such as barrel 22, is believed evident from the foregoing description. Specifically, co-rotation of the screw set serves to advance material during processing thereof from the barrel inlet to the barrel outlet. Simultaneously, steam or other heat exchange media is directed into the core 462 through the union 466 and the extension of shaft 452 beyond the end of the extruder barrel. This media flows through the core 462 and groove 480 owing to the communicating apertures 484. This provides an increased level of thermal energy to the process. The reverse flight section 478 also serves to retard the flow of material at the forward end of the screw 450.

FIG. 15 illustrates an extruder assembly 488 made up of an extruder 24, back pressure valve assembly 128, dispersal hood 310, and predryer 26. The extruder 24 is as previously described having solid core screws. However, as a matter of plumbing convenience, the back pressure valve assembly 128 is spaced from the forward outlet of the extruder barrel 64 and an elongated, tubular extension pipe 490 is operably coupled between the outlet of the extruder barrel and the inlet of the back pressure valve. A further delivery pipe 492 extends from the outlet of the back pressure valve assembly 128 to a die/knife assembly 494 situated to deliver cut extrudate into the dispersal hood 310. In this instance, the hood 310 is positioned directly above the predryer 26, so that the cut extrudate descends directly into the predryer inlet without the use of any conveyor or the like. Although not shown in detail, it will be appreciated that an HIP preconditioner is situated upstream of the extruder 24, whereas the final dryer 28 is located downstream of predryer 26.

FIG. 16 depicts an alternative extruder assembly 496 having an extruder 24a, a back pressure valve assembly 128, and a dispersal hood 310. In this case, the extruder 24a is equipped with a barrel 64a and a pair of hollow core extrusion screws 450 of the type described in connection with FIGS. 12-18, and having a pair of rotary unions 466; a steam line 467 is operably coupled with each union 466, permitting introduction of heat exchange media into the interior of the extruder screws. The barrel 64a has an outlet 498 extending from the top thereof, with an L-shaped delivery tube 500 between the outlet 498 and the inlet of the back pressure valve assembly 128. A delivery tube 502 extends from the outlet of assembly 128 to the die/knife assembly 494. As depicted, the product from hood 310 is delivered to predryer 26. Alternately, as shown in phantom in FIG. 16, the barrel 64a may be equipped with an outlet 498 at the bottom of the barrel section, with an L-shaped delivery tube 500a leading to the back pressure valve assembly 128. The FIG. 16 assembly was used in Runs 5-12 of the Example.

An alternate form of hollow core screw may be provided by axially boring the initially solid core screws 70, 72 along the length thereof to provide a central passageway for heat exchange media. In this alternative, the screws 70, 72 would each be equipped with a delivery tube 468 and rotary union 466, in order to allow injection of heat exchange media into the central passageway.

### Processing Conditions

As noted above and set forth in FIG. 1, the invention is advantageously carried out through use of an initial preconditioner serving to moisturize and partially cook the mixture of starting ingredients, followed by passage through a twin-screw extruder with subsequent drying, preferably in a two-stage drying system made up of a predryer and a primary dryer. In addition, a feature of the invention involves the ability to retort the extrudate either immediately off of the extruder (FIG. 1, 29a) after predrying (FIG. 1, 29b), or after final drying (FIG. 1, 29c) without undue product degradation.

More generally, the retort-stable products of the invention are produced by an overall process which involves energy inputs in the form of SME and STE. Total SME is essentially completely derived from the heat, shear, and friction generated in the extruder, because the SME contributed from the preconditioner is negligible. On the other hand, STE inputs can be derived both from the preconditioner and the extruder, both normally based upon thermal energy incident to the addition of steam and/or ingredients such as meat. The steam may be added directly in the case of the preconditioner, and directly and/or indirectly in the extruder.

The following sets forth details respecting SME and STE inputs to the process. It is to be understood that this information relates to the preconditioner/extruder process, apart from subsequent retorting.
SME contributed by the preconditioner—very low and can be considered essentially negligible
SME contributed by the extruder—about 5-50 kWhr/T, more preferably about 8-40 kWhr/T
STE contributed by the preconditioner—about 15-90 kWhr/T, more preferably about 20-80 kWhr/T
STE contributed by the extruder—about 0-90 kWhr/T, more preferably about 5-75 kWhr/T*
Total process SME—about 5-50 kWhr/T, more preferably about 8-40 kWhr/t
Total process STE—about 15-180 kWhr/T, more preferably about 25-155 kWhr/T
Total SME/STE ratio—about 0.1:1 -0.95:1, more preferably about 0.13:1 -0.85:1
Total energy to process, total SME+total STE—about 20-200 kWhr/T, more preferably from about 35-165 kWhr/T
*Where there is no direct or indirect application of steam to the extruder, the STE value will be in some cases be zero or near-zero (see Runs 7-12 from the Example).

In more detail, during preconditioning, the starting ingredients are processed at atmospheric or near-atmospheric pressures, with injection of steam and water, for a residence time period of from about 0.5-2.5 minutes, more preferably from about 1-1.5 minutes. The final temperature of the product emerging from the preconditioner should be from about 55-95° C., more preferably from about 60-85° C. Preconditioning typically results in a cook value (measured by the extent of gelatinization of starch-bearing ingredients) of from about 15-60%, more preferably from about 25-50%.

During extrusion, the preconditioned product is subjected to pressures on the order of from about 3200-8500 kpa, more preferably from about 3500-8000 kpa. The temperature of the extrudate should be in the range of from about 65-100° C., more preferably from about 70-90° C. The extruder screws are rotated at a rate of from about 200-700 rpm, more preferably from about 250-600 rpm. The residence time of the material in the extruder ranges from about 12-40 seconds, more preferably from about 15-30 seconds. The moisture level of the as-extruded product should be from about 20-50% by weight, more preferably from about 25-45% by weight.

Final retorting is generally carried out in a steam-fed pressure vessel where the extrudate is placed in a sealed container and heated in the pressure vessel at a pressure of from about 4-12 psi, more preferably from about 6-10 psi, and a temperature of from about 105-170° C., more preferably from about 120-160° C. for a period of from about 3-60 minutes, more preferably from about 10-25 minutes. In most preferred practice, the extrudate is retorted directly after extrusion with only minimal moisture loss, or after predrying as described above.

### Feed Ingredients

In general, the present methods are usable in connection with virtually standard feed recipe, which generally include respective quantities of grain and/or legumes, starch, protein, and fat, and optionally meat. The grain/legume content may be taken from a wide variety of sources, such as wheat, soy, corn, potato, pea, bean, oat, rice, flax, barley, millet, rye, buckwheat, beet, or any other grains belonging to the Poaceae family, and mixtures thereof. These grains may also supply the starch content for the recipes, or alternately starches may be directly added. Likewise, grains may also provide a measure of protein, but other non-grain sources may be employed, such as fish, insect, and bone meals. Meats may be selected from poultry, beef, pork, and fish. The feed recipes are of course designed for particular animals and their nutritional requirements, and particular ingredient selection and use is well within the skill of the art. Notably, the present invention does not require the presence of any specialized binders, such as wheat gluten; indeed, the use of these is disfavored because of cost, and normally the ingredient mixtures will contain no more than about 12% by weight gluten.

A particular advantage of the present invention is that substantial quantities of fresh meat may be added to the feed recipes, while still obtaining high quality, retort-stable feeds.

### Retorted Product Integrity Index

In order to provide a quantitative measure of retort stability for the products of the invention, the following test is carried out.

1. Place 25 g of the pet feed sample in a canning jar or other comparable container, together with 37 g of gravy and 50 ml of water. The gravy is prepared by cooking a 5% by weight solution of tapioca starch in water until clear.

2. Retort cook the container for 5 minutes in a pressure retort vessel under a pressure of 7 psi (111° C.), and then cool the sample at ambient conditions for 30 minutes.

3. Open the sealed container and select 3-10 pieces of product kibble that are the best representation of the sample as a whole.

4. A Texture Analyzer instrument (example is a Perten TexVol TVT-300XPH) is used to measure the force (g) required to penetrate each piece when the head is fitted with an appropriate probe (in this case, probe #673045 is used as it resembles a canine tooth).

5. Multiple product pieces are tested and an average value obtained representing the peak force required to penetrate the sample.

As an example, several pet food samples were subjected to the retort process and integrity test as described. Those samples which required an average peak force of greater than 400 grams were deemed retort stable and retained sufficient integrity to be identifiable as a kibble. In practice, the retort integrity value (average peak force required to penetrate the kibble) for the products of the invention should be greater than about 400 grams.

### EXAMPLE

The following example sets forth typical practice of the present invention in terms of method and apparatus. It is to be understood, however, that this example is provided by way of illustration only and nothing therein should be taken as a limitation on the overall scope of the invention.

In this example, a series of comparative extrusion run tests were performed using a conventional single-screw extruder (Wenger Model X115, equipped with cut flight screw) versus a twin-screw extruder in accordance with the invention, as described above (Wenger Model TT760), and having the hollow core screws described above with reference to FIGS. 8-14. The extrudates from these runs, without final drying, were subjected to retort conditions in order to determine the integrity of the retorted products.

In each case, the overall extrusion assembly included an HIP preconditioner equipped with a static mixer steam/water inlet. The outlet of the preconditioner was coupled to the inlet of the extruder barrel. A drying assembly was used downstream of the extruder, which was made up of a predryer and a final dryer. The HIP preconditioner and the drying assembly are described above.

Specifically, the following dry ingredient recipes were used.
Dry Recipe 1—Grain-Free
   poultry meal—780 lbs—26%
   whole potato flour—1080 lbs—36%
   yellow pea flour—780 lbs—26%
   beet pulp—240 lbs—8%
   flax meal—90 lbs—3%
   salt—30 lbs—1%
Dry Recipe 2—Grain- and Poultry Meal-Free
   whole potato flour—880 lbs—44%
   yellow pea flour—880 lbs—44%
   beet pulp—160 lbs—8%
   flax meal—60 lbs—3%
   salt—20 lbs—1%
Dry Recipe 3—With Grain
   poultry meal—600 lbs—30%
   rice—600 lbs—30%
   corn gluten meal—240 lbs—12%
   corn—560 lbs—28%
      In addition, two separate meat recipes were used.
Meat Recipe 1
   mechanically separated chicken—3500 lbs—100%
Meat Recipe 2
mechanically separated chicken—500 lbs—99.8%
   multi-enzyme complex—1 lb—0.2%

The X115 single-screw extruder was equipped with a back pressure valve with two different die configurations. In the pipe die configuration, an elongated delivery pipe was secured to the outlet of the back pressure valve, with the outboard end of the pipe having a backup die with a ½-inch outlet hole. In the no pipe die configuration, the outlet end of the extruder barrel was equipped with a final die with ¼-inch diameter outlet holes. A rotating knife was used to cut the extrudate emerging from each die assembly.

The TT760 extruder used a standard die setup including an elongated outlet pipe coupled to the outlet of the back pressure valve which fed directly into the downstream drying assembly, with no transition conveyor. The outlet pipe was equipped with a backup die plate having a ¾-inch hole and a final die containing six ¼-inch round holes. A rotating knife was used to cut the extrudate emerging from each die assembly. The back pressure valve was located between the outlet of the extruder and the final die, as illustrated in FIGS. 15-16. In all of the Runs 5-12, steam was injected into the hollow core screws in order to increase the STE input to the process. In Runs 5-6, steam was directly injected into the extruder barrel via the injection ports 92, 94 to provide additional STE input.

Four Runs, nos. 1-4, were carried out using the X115, and eight comparative Runs, nos. 5-12, were carried out using the TT760. The following Table 1 sets forth the general makeup of each of these Runs.

TABLE 1

| | Dry | Meat | Meat | Die | |
|---|---|---|---|---|---|
| Run | Recipe | Recipe | (kg/hr) | Setup | Comments |
| 1 | 1 | 1 | 60 | No pipe | Grain-free diet/20% meat |
| 2 | 3 | 1 | 60 | No pipe | Grain diet/20% meat |
| 3 | 3 | 1 | 60 | Pipe | Grain diet/20% meat |
| 4 | 1 | 1 | 60 | Pipe | Grain-free diet/20% meat |
| 5 | 1 | 1 | 100 | Standard | Grain-free diet/20% meat |
| 6 | 1 | 1 | 400 | Standard | Grain-free diet/80% meat |
| 7 | 1 | 1 | 400 | Standard | Grain-free diet/80% |
| | | | | | meat/enzyme added¹ |
| 8 | 1 | 2 | 400 | Standard | Grain-free diet/80% |
| | | | | | meat/with enzyme² |
| 9 | 2 | 1 | 400 | Standard | Grain-free and poultry |
| | | | | | meal-free diet/80% meat |
| 10 | 2 | 1 | 100 | Standard | Grain-free and poultry |
| | | | | | meal-free diet/80% meat |
| 11 | 3 | 1 | 100 | Standard | Grain diet/20% meat |
| 12 | 3 | 1 | 400 | Standard | Grain diet/80% meat |

¹0.1% of meat weight of protease enzyme (Liquipanole T-200) added at the preconditioner using a peristaltic pump
²0.1% of meat weight of protease enzyme (Liquipanole T-200) added to the meat recipe before processing, by mixing the enzyme with meat in a steam-jacketed kettle with agitation for 30 minutes to a temperature of 40-50° C.

The following Tables 2 and 3 set forth the run conditions for Runs 1-12.

TABLE 2

| Parameter | Run 1 | Run 2 | Run 3 | Run 4 |
|---|---|---|---|---|
| dry recipe density--kg/m³ | 665 | 651 | 621 | 635 |
| dry recipe rate--kg/hr | 296 | 298 | 304 | 295 |
| HIP mixing intensity--% | 20 | 20 | 20 | 20 |
| HIP large side speed--rpm | 292 | 292 | 292 | 292 |
| HIP small side speed--rpm | 298 | 298 | 298 | 298 |
| steam to HIP--kg/hr | 17.9 | 18.1 | 17.9 | 18.0 |
| water to HIP--kg/hr | 26.5 | 27.2 | 21.7 | 24.0 |
| Meat Recipe 1 to HIP--kg/hr | 60 | 60 | 60 | 60 |
| HIP product discharge temp--° C. | 66 | 67 | 66 | 70 |
| extruder shaft speed--rpm | 300 | 280 | 280 | 280 |
| extruder motor load--% | 59.7 | 62.1 | 69.4 | 64.0 |
| extruder motor power--kW | 22.8 | 23.3 | 25.7 | 23.0 |
| extruder zone 1 temp--° C. | 70/71 | 70/64 | 60/56 | 60/63 |
| extruder zone 2 temp--° C. | 75/78 | 70/73 | 65 | 65/66 |
| extruder zone 3 temp--° C. | 80 | 75 | 65/62 | 65/66 |
| extruder zone 4 temp--° C. | 80 | 75/76 | 70/76 | 70/66 |
| extruder zone 5 temp--° C. | 80 | 80 | 75 | 75 |
| extrudate discharge | 350 | 400 | 392 | 360 |
| density--kg/m³ | | | | |
| moisture of extrudate at die--% | 29.7 | 24.6 | 24.7 | 23.4 |
| SME--kWhr/T | 77.2 | 77.8 | 84.5 | 77.9 |
| STE--kWhr/T | 37.5 | 48 | 46.5 | 46 |
| SME/STE | 2.6:1 | 1.6:1 | 1.8:1 | 1.7:1 |

TABLE 3

| Parameter | Run 5 | Run 6 | Run 7 | Run 8 | Run 9 | Run 10 | Run 11 | Run 12 |
|---|---|---|---|---|---|---|---|---|
| dry recipe density--kg/m³ | 483 | 483 | 483 | 483 | 483 | 483 | 483 | 483 |
| dry recipe rate--kg/hr | 328 | 472 | 511 | 478 | 508 | 452 | 404 | 500 |
| HIP large side speed--rpm | 250 | 200 | 200 | 200 | 200 | 250 | 250 | 250 |
| HIP small side speed--rpm | 300 | 400 | 400 | 400 | 450 | 400 | 400 | 400 |
| steam to HIP--kg/hr | 32 | 39 | 0 | 37 | 39 | 41 | 36 | 0 |
| water to HIP--kg/hr | 51 | 0 | 0 | 0 | 0 | 70 | 69 | 0 |
| Meat Recipe to HIP--kg/hr | 100 | 320 | 430 | 389 | 380 | 100 | 100 | 400 |
| HIP product discharge temp--° C. | 57 | 69 | 60 | 60 | 63 | 66 | 62 | 65 |
| extruder shaft speed--rpm | 402 | 351 | 365 | 408 | 397 | 397 | 403 | 501 |
| extruder motor load--% | 42 | 38 | 40 | 45 | 41 | 48 | 49 | 36 |
| extruder motor power--kW | 11 | 6 | 8 | 14 | 10 | 13 | 15 | 11 |
| maximum pressure--kpa | 6798 | 5959 | 4720 | 6005 | 3682 | 8289 | — | 5253 |
| extruder discharge temp--° C. | 81 | 80 | 79 | 90 | 84 | 80 | 79 | 95 |
| moisture of extrudate at die--% | 29.8 | 35.6 | 37 | 35.5 | 37.1 | 27.3 | 27.7 | 34.9 |
| direct steam to extruder barrel-- kg/hr | 22 | 23 | 0 | 0 | 0 | 0 | 0 | 0 |
| moisture of extrudate after predryer--% | 12.1 | 14.3 | 23.5 | 21.1 | 25.5 | 12.7 | 8.5 | 14.3 |
| preconditioner STE--kWhr/T | 54 | 72 | 24 | 69.7 | 72 | 69 | 60.4 | 29 |
| extruder STE--kWhr/T | 33.2 | 33 | 0 | 0 | 0 | 0 | 0 | 0 |
| total STE--kWhr/T | 87.2 | 105 | 24 | 69.7 | 72 | 69 | 60.4 | 29 |
| total SME--kWhr/T | 34 | 13 | 17 | 33 | 20 | 30 | 35 | 22 |
| total SME + STE-kWhr/T | 121.2 | 118 | 41 | 102.7 | 92 | 99 | 95.4 | 51 |
| total SME/STE | 0.39:1 | 0.2:1 | 0.71:1 | 0.47:1 | 0.28:1 | 0.43:1 | 0.58:1 | 0.76:1 |

Samples of the products of Runs 1-6 and 9-12 were taken directly from the extrusion die and not subjected to specific drying regimen. However, these samples were allowed to air dry overnight before retort testing. Additional samples of Runs 5, 6, and 9-12 were pre-dried using a small, relatively low-temperature, three-pass predryer. The predryer was run with 180° C. heated air, with retention times of 1, 2, and 3 minutes respectively for the three passes, for a total drying time of 6 minutes. These predried samples are noted in Table 4 below as Runs 5A, 6A, 9A, 10A, 11A, and 12A.

The extrudates from all Runs were identically retorted using the following procedure. 25 g of the respective extrudates were placed in jars along with 37 g of gravy. The gravy was prepared by cooking a solution of 5% tapioca starch in water (1 L water plus 50 g tapioca flour) until clear. After gravy addition, another 50 mL of water was added to the jars. The jars were then closed and pressure cooked at 7 psi for 10 minutes until boiling, followed by 5 minutes of further cooking, and a final 30 minutes of cooling at ambient pressure. The retorted products were then evaluated immediately after removal from the pressure cooker.

The following Table 4 sets forth the as-tested moisture levels of the products, and product characteristics bearing upon kibble integrity, immediately after the retort procedure. In addition, mold form characteristics were noted, to describe whether the products as a whole held the shape of the retort container, but this characteristic had little to do with kibble integrity.

TABLE 4

| Run # | Moisture % | Appearance After Retorting |
|---|---|---|
| 1 | 14.25 | very poor kibble integrity, mushy, little |
| | | cloudy gravy |
| 2 | 17.80 | very poor kibble integrity, mushy, with dark |
| | | gravy |
| 3 | 16.46 | poor kibble integrity, mushy with dark gravy |
| 4 | 13.09 | poor kibble integrity, mushy with broth gravy |
| 5 | 11.94 | kibble extremely mushy, very little cloudy |
| | | gravy |
| 5A | 8.40 | soft kibble to touch, little to no gravy |
| 6 | 15.14 | soft kibble to touch, cloudy gravy |
| 6A | 9.68 | soft outer/firm inner kibble with broth gravy |
| 9 | 23.98 | hard to touch (unable to mush/break), lots of |
| | | clear gravy |
| 9A | 14.14 | firm to touch (unable to mush/break), lots of |
| | | clear gravy |
| 10 | 14.08 | firm to touch, able to mush with force, clear |
| | | gravy |
| 10A | 10.05 | firm to touch, able to mush with force, clear |
| | | broth gravy |
| 11 | 13.98 | firm to touch, able to mush with broth gravy |
| 11A | 8.50 | soft outer/firm inner kibble with dark broth |
| | | gravy |
| 12 | 17.35 | firm to touch, able to mush with clear gravy |
| 12A | 11.43 | soft to touch, able to mush with clear gravy |

These results confirm that the products in accordance with the present invention (Runs 5-12) did not exhibit the same degree of mushiness as the comparative products of Runs 1-4, and all of the latter had lesser degrees of integrity. Enzyme addition into the preconditioner or as an additive to the meat fraction appeared to give no significant product differences.

In another test run, a high meat canine diet was extruded using the apparatus of FIG. 16 and standard die setup. The SME/STE ratio for this run was 0.14:1.0. Samples of the extrudate were taken off of the extruder (moisture level 39.42%), after predrying (moisture level 29.35%), and after final drying (moisture level 16.39%). These samples were then immediately retorted under identical conditions, and all products were firm yet compressible through the entirety of the kibble. This establishes that the drying level of the extrudate is not a significant factor in production of retort-stable products.

1-31. (canceled)

32. A process for preparing a feed product comprising the steps of forming a mixture of feed ingredients, including the steps of preconditioning the mixture while adding steam thereto so that the preconditioned mixture has a temperature of from about 55-95° C., extruding the preconditioned mixture to produce an extrudate, and retorting the extrudate.

33. The process of claim 32, said extrudate having a retort integrity value of greater than about 400 grams.

34. The process of claim 32, said process including the step of imparting specific thermal energy to the mixture at a level of from about 15-90 kWhr/T during said preconditioning step.

35. The process of claim 32, said extruder including an elongated barrel with at least one elongated, axially rotatable, helically flighted screw within said barrel, said extruding step including the step of rotating said at least one screw and moving said preconditioned mixture through said barrel.

36. The process of claim 35, including the step of directly injecting steam into said barrel during said extrusion.

37. The process of claim 35, said at least one screw having a hollow core, including the step of injecting steam into said hollow core during said extrusion step.

38. The process of claim 35, including the step of rotating said at least one screw at a rate of from about 200-700 rpm.

39. The process of claim 35, said extruder being a twin-screw extruder.

40. The process of claim 32, said retorting step comprising the steps of placing said extrudate in a sealed container, and subjecting said sealed container to elevated temperatures and pressures over a period of time in order to sterilize said extrudate therein.

41. The process of claim 40, said elevated temperature being from about 105-170° C., and said pressure being from about 4-12 psi.

42. The process of claim 40, said sealed container selected from the group consisting of a can or pouch.

43. The process of claim 32, including the step of drying said extrudate to a moisture level of from about 12-30% by weight prior to said retorting step.

44. The process of claim 32, including the step of retorting said extrudate without substantial drying thereof.

45. The process of claim 32, including the step of retorting said extrudate with other feed ingredients.

46. The process of claim 32, including the step of cutting said extrudate to form extrudate pieces, and then retorting the extrudate pieces.

47. The process of claim 32, including the step of subjecting said mixture to specific mechanical energy and specific thermal energy inputs, with the ratio of the total specific mechanical energy input to the total specific thermal energy input prior to retorting being from about 0.1:1-0.95:1.

48. The process of claim 32, including the step of subjecting said mixture to specific mechanical energy inputs, the specific mechanical energy imparted to said mixture said extrusion step being from about 5-50 kWhr/T.

49. The process of claim 32, including the step of subjecting said mixture to specific thermal energy inputs, the specific thermal energy imparted to said mixture during said preconditioning step being from about 15-90 kWhr/T, and the specific thermal energy imparted to said mixture during said extrusion step being from about 5-75 kWhr/T.

50. The process of claim 32, including the step of subjecting said mixture to specific mechanical energy inputs and specific thermal energy inputs, the total specific mechanical energy and specific thermal energy inputs to said mixture during said process being from about 20-200 kWhr/T.
